(19) United States
(12) Patent Application Publication
(10) Pub. No.: US 2025/0126641 A1
(43) Pub. Date: Apr. 17, 2025

(54) MULTI-ACCESS POINT (MULTI-AP) JOINT TRANSMISSION IN A WIRELESS NETWORK

(71) Applicant: NEWRACOM, Inc., Irvine, CA (US)

(72) Inventors: Heejung YU, Daejeon (KR); Joonsoo LEE, Seoul (KR); Si-Chan NOH, Seoul (KR); Il-Gu LEE, Seoul (KR)

(73) Assignee: NEWRACOM, Inc., Irvine, CA (US)

(21) Appl. No.: 18/886,794

(22) Filed: Sep. 16, 2024

Related U.S. Application Data
(60) Provisional application No. 63/590,762, filed on Oct. 16, 2023.

(51) Int. Cl. H04W 74/0808; H04K 1/04; H04W 84/12

(52) U.S. Cl. CPC H04W 74/0808; H04K 1/04; H04W 84/12

(57) ABSTRACT

An embodiment is method performed by an access point (AP) for performing a joint transmission to jointly transmitting a frame to a station (STA) with one or more other APs. The method includes determining a scrambling seed that is to be used for the joint transmission, determining a basic service set (BSS) color for a virtual BSS that is jointly operated by the AP and the one or more other APs based on identifiers associated with the AP and the one or more other APs, and transmitting, as part of the joint transmission, a frame to the STA using the scrambling seed, wherein a preamble of the frame indicates the BSS color for the virtual BSS.

### CROSS-REFERENCE TO RELATED APPLICATION

This application claims the benefit of U.S. Provisional Application No. 63/590,762 filed Oct. 16, 2023, which is hereby incorporated by reference.

### TECHNICAL FIELD

The present disclosure generally relates to wireless communications, and more specifically, relates to performing a multi-access point (multi-AP) joint transmission in a wireless network.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHZ, 6 GHZ, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

Multiple access point (AP) coordination (which may also be referred to as multi-AP coordination) is expected to be one of the features to be included in next generation wireless networks (e.g., wireless networks that are to implement the beyond IEEE 802.11be or IEEE 802.11bn wireless networking standard). With multi-AP coordination, multiple APs may coordinate with each other to perform a joint transmission to a STA, in which multiple APs simultaneously transmit the same frame to the STA. The multiple APs that perform the joint transmission may be regarded as a single virtual AP operating a virtual basic service set (BSS). When multiple APs perform a joint transmission to a STA, there may be stringent requirements in terms of how the frames should be generated and transmitted for the joint transmission to be successful.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.
a. FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a frame exchange sequence for a channel sounding process and multi-AP joint transmission, according to some embodiments.

FIG. 11 is a diagram showing how basic service set (BSS) color can be generated using a hash function, according to some embodiments.

FIG. 12 is a diagram showing how BSS color can be generated using an exclusive OR (XOR) operation, according to some embodiments.

FIG. 13 is a flowchart of a method for participating in a multi-AP joint transmission, according to some embodiments.

### DETAILED DESCRIPTION

The present disclosure generally relates to wireless communications, and more specifically, relates to performing a multi-access point (multi-AP) joint transmission in a wireless network.

As mentioned above, when multiple access points (APs) perform a joint transmission to a station (STA) (also referred to herein as a multi-AP joint transmission), there may be stringent requirements in terms of how the frames should be generated and transmitted for the joint transmission to be successful (e.g., for the STA to successfully decode the frames). For example, when performing a multi-AP joint transmission, all of the APs should simultaneously transmit frames using the same scrambling seed so that the waveforms (except the beamforming matrices) transmitted by the APs for the relevant parts of the frames (e.g., the signal part and data part of the frames) are identical. A scrambling seed is used for randomizing data in a frame. If two different APs use different scrambling seeds, the waveforms that they transmit can be different even if they are transmitting the same original data (before randomization). Thus, the APs need to use the same scrambling seed in order for the transmitted waveforms to be the same. Also, the same basic service set (BSS) color should be indicated in the frame preambles (e.g., in the universal signal (U-SIG) field of the preamble). The BSS color indicated in the frame preamble should be the BSS color for the virtual BSS that is jointly operated by the multiple APs, and should be different from the BSS colors for the (non-virtual) BSSs that are individually operated by the APs.

Embodiments are described herein that allow multiple APs to perform a joint transmission with matching parameters (e.g., matching scrambling seeds and/or BSS colors). An embodiment is a method performed by an AP for participating in a joint transmission to a station STA with one or more other APs. The method includes determining a scrambling seed that is to be used for the joint transmission, determining a BSS color for a virtual BSS that is jointly operated by the AP and the one or more other APs based on identifiers associated with the AP and the one or more other APs, and transmitting, as part of the joint transmission, a frame to the STA using the scrambling seed, wherein a preamble of the frame indicates the BSS color for the virtual BSS.

A benefit provided by embodiments described herein is that they allow multiple coordinating APs to perform a joint transmission to a STA with matching parameters, which enables the joint transmission to be successful. For example, for a multi-AP joint transmission to be successful, all of the APs participating in the joint transmission should transmit their frames with matching scrambling seeds and BSS colors. Also, in the case where multiple APs implementing different physical layer (PHY) versions perform a multi-AP joint transmission, all of the APs should transmit their frames with matching PHY version identifiers. Embodiments described herein allow multiple APs to perform a joint transmission with matching scrambling seeds, BSS colors, and PHY version identifiers, thereby satisfying the requirements for the joint transmission to be successful.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special- purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

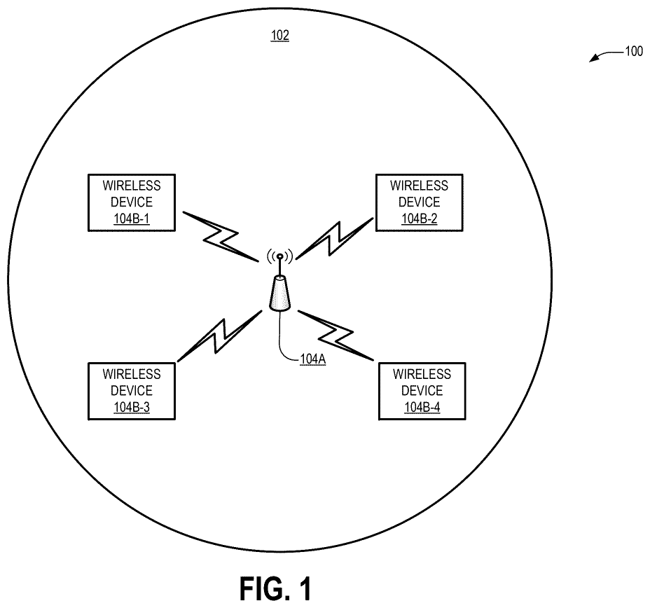

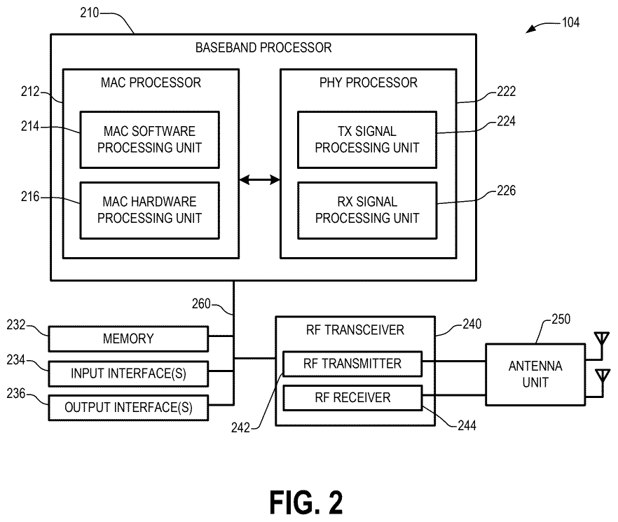

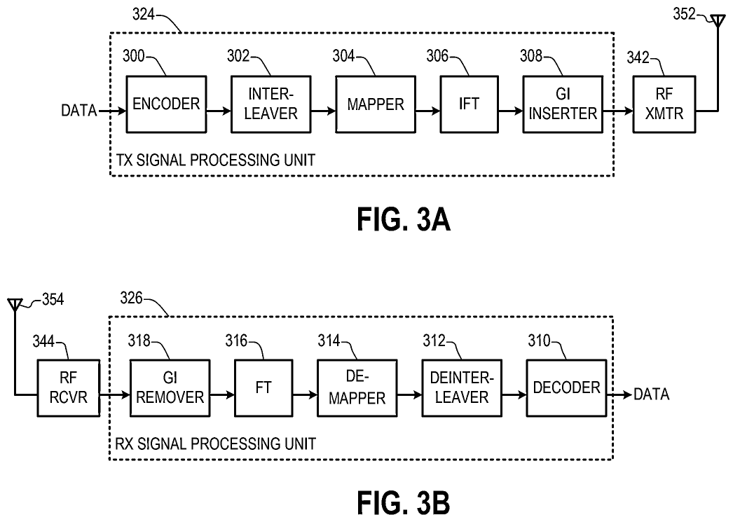

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

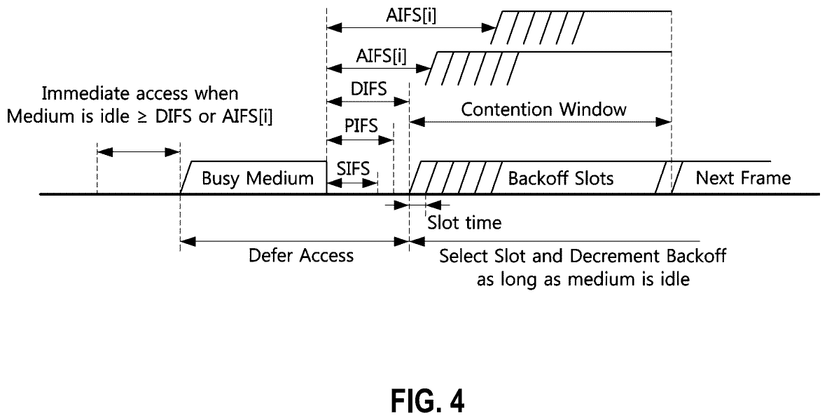

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIF[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

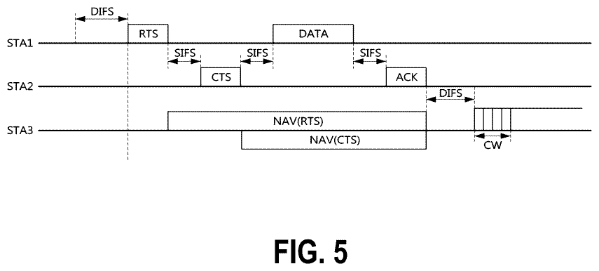

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

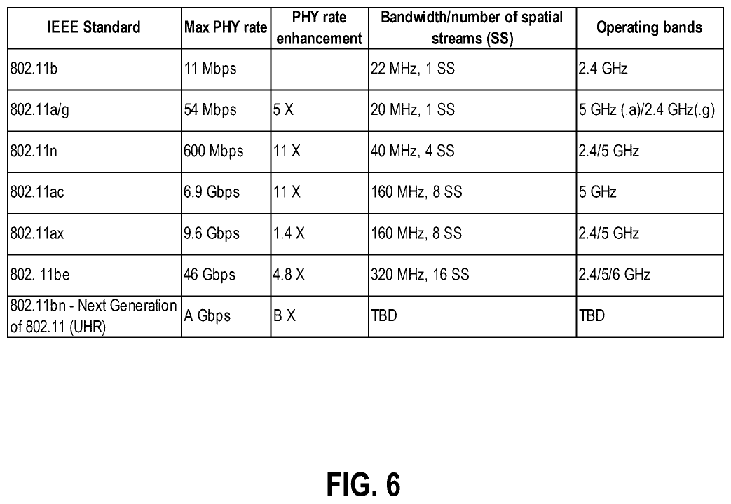

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

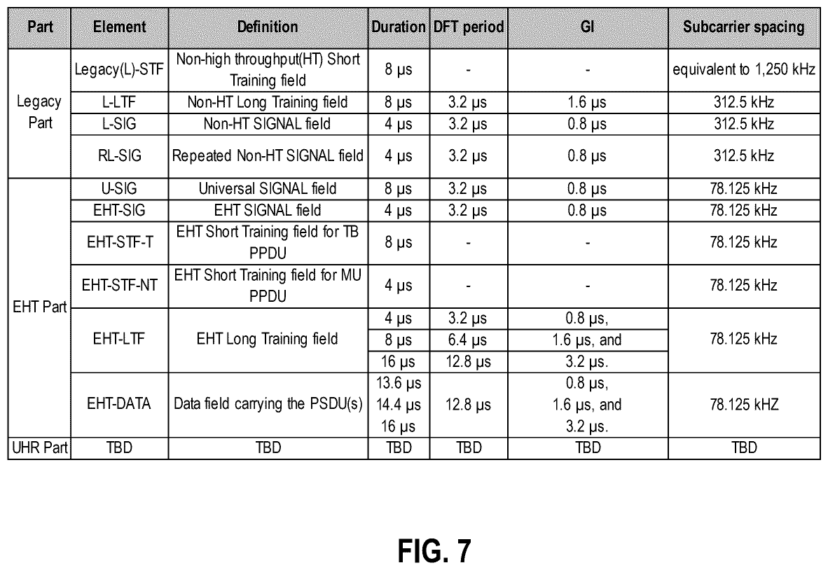

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision- free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

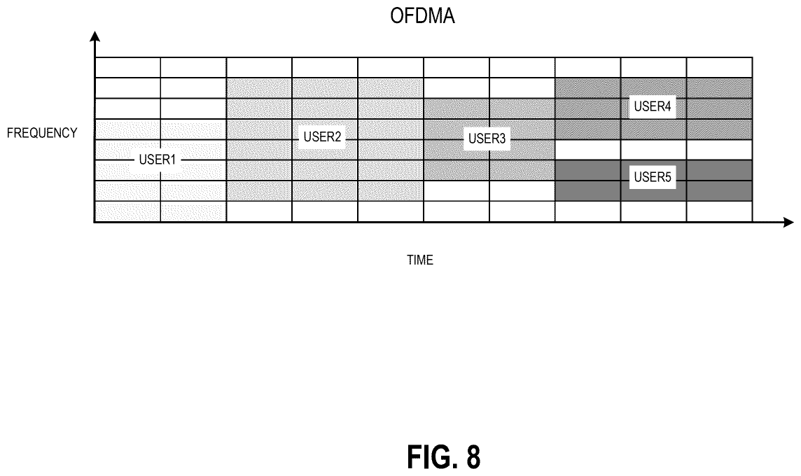

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

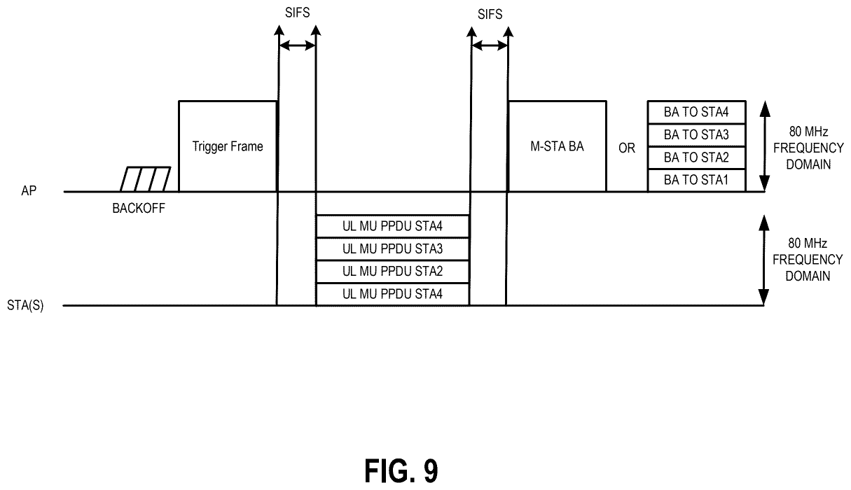

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

Multiple access point (AP) coordination (which may also be referred to as multi-AP coordination) is expected to be one of the features to be included in next generation wireless networks (e.g., wireless networks that are to implement the beyond IEEE 802.11be or IEEE 802.11bn wireless networking standard) to help increase throughput. With multi-AP coordination, multiple APs coordinating with each other may form a single virtual AP that operates a virtual BSS (that is, the multiple APs may jointly operate a virtual BSS). The multiple APs may perform a joint transmission to a STA by simultaneously transmitting the same frame to the STA. For the joint transmission to be successful, the waveforms transmitted by the APs for the signal part of the frames (e.g., legacy signal (L-SIG) field, universal signal (U-SIG) field, and/or ultra high reliability signal (UHR-SIG) field of the frame preamble) and the data part of the frames should be identical.

APs may perform a joint transmission during a channel sounding process (e.g., when transmitting a null data packet announcement (NDPA) frame) and following a channel sounding procedure (e.g., when transmitting a data frame).

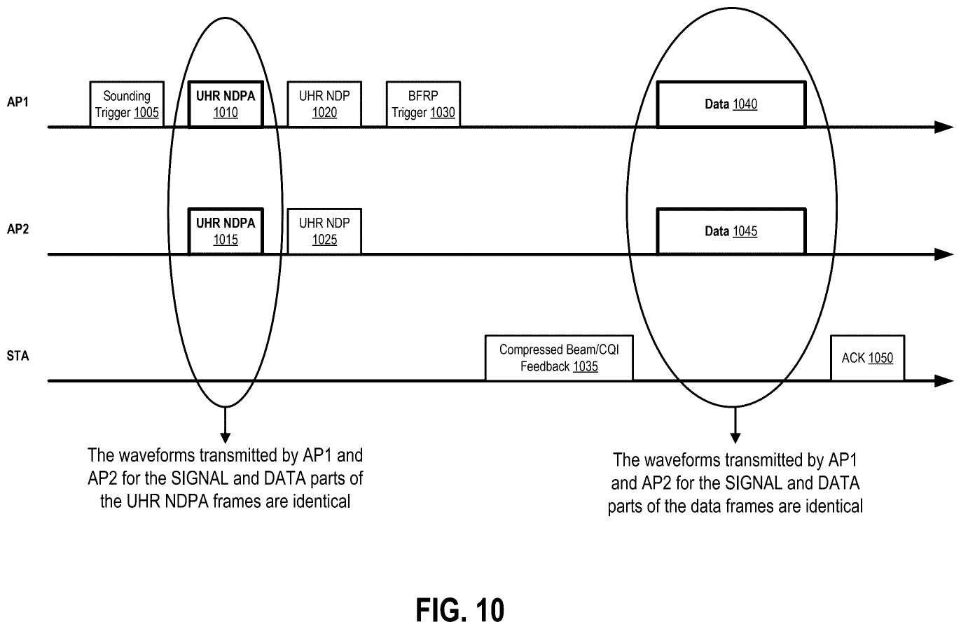

FIG. 10 is a diagram showing a frame exchange sequence for a channel sounding process and multi-AP joint transmission, according to some embodiments.

As shown in the diagram, the frame exchange sequence may involve a first AP (AP1), a second AP (AP2), and a STA. AP1 and AP2 may form a single virtual AP that operates a virtual BSS (AP1 and AP2 jointly operate a virtual BSS).

As shown in the diagram, AP1 may initiate a channel sounding process by transmitting sounding trigger frame 1005. AP1 and AP2 may then perform a joint transmission by simultaneously transmitting UHR NDPA frame 1010 and UHR NDPA frame 1015, respectively. The contents of UHR NDPA frame 1010 and UHR NDPA frame 1015 may be identical. AP1 and AP2 may then simultaneously transmit UHR NDP frame 1020 and UHR NDP frame 1025, respectively. AP1 may then transmit beamforming report poll (BFRP) trigger frame 1030 to solicit compressed beamforming/channel quality information (CQI) feedback information from the STA. Responsive to receiving BFRP trigger frame 1030, the STA may transmit a compressed beamforming/CQI feedback frame 1035 that includes compressed beamforming/CQI feedback information (which the STA may determine based on the UHR NDP frames 1020 and 1025). This completes the channel sounding process.

AP1 and AP2 may then perform a joint transmission by simultaneously transmitting data frame 1040 and data frame 1045, respectively, to the STA. The contents of data frame 1040 and data frame 1045 may be identical. Responsive to receiving data frame 1040 and data frame 1045, the STA may transmit ACK frame 1050 to acknowledge that it received the data frames.

From the perspective of the STA, AP1 and AP2's joint transmission of the UHR NDPA frames (UHR NDPA frame 1010 and UHR NDPA frame 1015) may be regarded as a single (virtual) UHR NDPA frame transmitted by a single (virtual) AP. Similarly, from the perspective of the STA, AP1 and AP2's joint transmission of the data frames (data frame 1040 and data frame 1045) may be regarded as a single (virtual) data frame transmitted by a single (virtual) AP.

For a joint transmission to be successful, the waveforms transmitted by the different APs participating in the joint transmission for the signal part and data part of the frames should be identical, except for the beamforming matrices. For example, the waveforms transmitted by AP1 and AP2 for the signal part and data part of the UHR NDPA frames should be identical. Also, the waveforms transmitted by AP1 and AP2 for the signal part and data part of the data frames should be identical. For this purpose, all of the APs participating in a joint transmission should transmit frames using the same scrambling seed.

In an embodiment, AP1 shares the scrambling seeds that are to be used for the joint transmissions with AP2. In an embodiment, AP1 shares the scrambling seeds with AP2 by including the scrambling seeds in sounding trigger frame 1005 (or another frame that is transmitted before sounding trigger frame 1005). AP1 may share a separate scrambling seed for each joint transmission (one scrambling seed for the joint transmission of UHR NDPA frames and one scrambling seed for the joint transmission of the data frames) or may share a single scrambling seed that is to be used for both joint transmissions. In an embodiment (e.g., if sounding trigger frame 1005 does not allow for indicating a scrambling seed), AP1 and AP2 may use the same predefined scrambling seed or independently generate the same scrambling seed (e.g., independent generate the same scrambling seed using predefined rules—any type of predefined rule(s) can be used so long as it results in both APs generating the same scrambling seed) and use that scrambling seed when performing a joint transmission. That is, AP1 and AP2 do not use a random scrambling seed when performing a joint transmission where the transmitted waveforms need to be identical. In the example shown in the diagram, AP1 and AP2 may transmit the UHR NDPA frames using the same scrambling seed so that the transmitted waveforms for the signal part and data part of the UHR NDPA frames are identical. Also, AP1 and AP2 may transmit the data frames using the same scrambling seed (which may be the same or different from the scrambling seed used for transmitting the UHR NDPA frames) so that the transmitted waveforms for the signal part and data part of the data frames are identical.

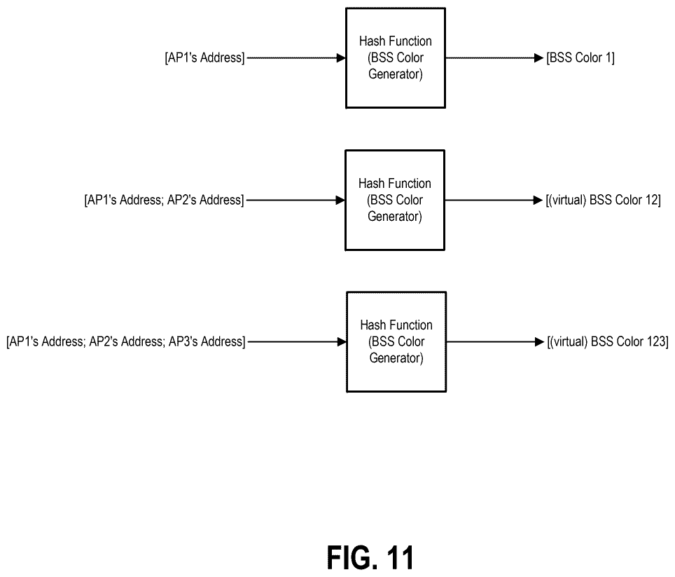

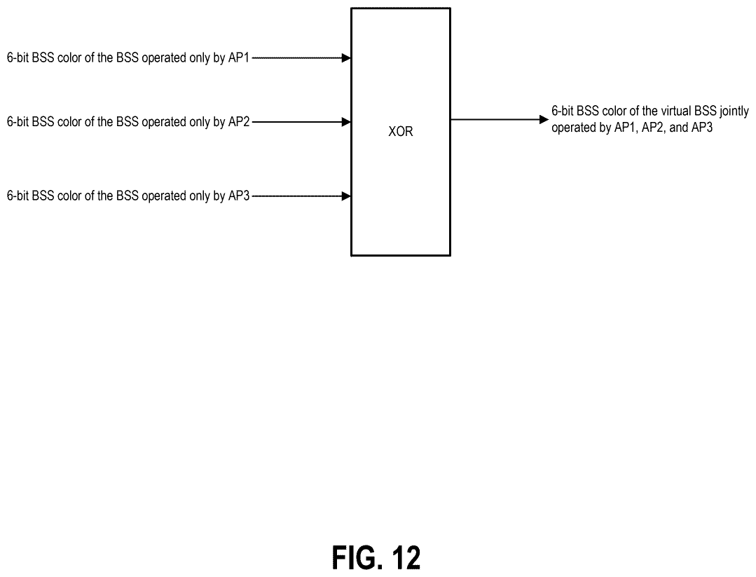

As mentioned above, when multiple APs perform a joint transmission, the BSS color indicated in the frame preambles should be the same. The BSS color indicated in the frame preambles should be the BSS color for the virtual BSS that is jointly operated by the multiple APs, and should be different from the BSS colors for the (non-virtual) BSSs that are individually operated by the APs. For this purpose, a way for APs to generate the BSS color for a virtual BSS is needed. Example ways to generate BSS color are shown in FIG. 11 and FIG. 12 and described in further detail herein below.

FIG. 11 is a diagram showing how BSS color can be generated using a hash function, according to some embodiments.

In an embodiment, the BSS color for a virtual BSS is generated based on identifiers associated with the APs that jointly operate the virtual BSS. The identifiers may be, for example, BSS identifiers (BSSIDs), BSS colors, or AP addresses (e.g., media access control (MAC) addresses), although other types of identifiers can be used.

If a BSS is operated by a single AP (the BSS is not a virtual BSS), then the BSS color for the BSS may be generated by applying a hash function to the single AP's address. Any suitable hash function can be used. For example, as shown in the diagram, the BSS color of a non-virtual BSS operated by AP1 (“[BSS Color 1]”) may be generated by applying a hash function to AP1's address. If a BSS is jointly operated by multiple coordinating APs (the BSS is a virtual BSS), then the BSS color for the virtual BSS may be generated by concatenating the identifiers associated with the APs that jointly operate the virtual BSS to generate a concatenated list of identifiers and applying a hash function to the concatenated list of identifiers. For example, as shown in the diagram, the BSS color for a virtual BSS jointly operated by AP1 and AP2 (“[BSS Color 12]”) may be generated by concatenating the addresses of AP1 and AP2 to generate a concatenated list of addresses (“[AP1's Address, AP2's Address]”) and applying a hash function to the concatenated list of addresses. Similarly, as shown in the diagram, the BSS color for a virtual BSS jointly operated by AP1, AP2, and AP3 (“[BSS Color 123]”) may be generated by concatenating the addresses of AP1, AP2, and AP3 to generate a concatenated list of addresses (“[AP1's Address, AP2's Address, AP3's Address]”) and applying a hash function to the concatenated list of addresses. The order in which identifiers are concatenated may vary depending on the implementation. In an embodiment, the identifiers are concatenated in order of the participation order of the APs in a multi-AP coordination process. In a multi-AP coordination process, a sharing AP (the AP that functions as the main coordinator for the multi-AP coordination) may transmit an invitation (or request for coordination) to one or more shared APs (the other APs that are to participate in the coordination) to request coordination. The order in which the sharing AP invites the shared APs may be considered the order of participation. In another embodiment, the identifiers are concatenated in ascending or descending order of the binary values of the identifiers. In an embodiment, the BSS color is encoded using six (6) bits. When transmitting a frame as part of a joint transmission, an AP may indicate the BSS color for the virtual BSS in the U-SIG field of the frame preamble.

FIG. 12 is a diagram showing how BSS color can be generated using an exclusive OR (XOR) operation, according to some embodiments.

If the hash function adds too much computational complexity to the system, a XOR operation can be used instead. For example, the BSS color for a virtual BSS that is jointly operated by multiple APs may be generated by applying a XOR operation to the BSS colors associated with the multiple APs in a bit-by-bit manner. For example, as shown in the diagram, a 6-bit BSS color for the virtual BSS that is jointly operated by AP1, AP2, and AP3 may be generated by applying a XOR operation to the 6-bit BSS color for the BSS individually operated by AP1, the 6-bit BSS color for the BSS individually operated by AP2, and the 6-bit BSS color for the BSS individually operated by AP3. Using a XOR operation to generate the BSS color for the virtual BSS is computationally simpler compared to using a hash function, but the probability of BSS color collision is higher, although there is still a chance of BSS color collision even when using a hash function. In an embodiment, if the BSS color generated for the virtual BSS is the same as the BSS color for a neighboring BSS (e.g., one of the BSSs individually operated by an AP), the BSS color generated for the virtual BSS can be changed using a BSS color change mechanism (e.g., the BSS color change mechanism specified in the IEEE 802.11be wireless networking standard).

When multiple APs perform a joint transmission, the APs should transmit their frames with matching PHY version identifiers (e.g., indicate the same PHY version identifier in the U- SIG field of the frame preamble) even if all of the APs do not implement the same PHY version. In an embodiment, when multiple APs implementing different PHY versions perform a joint transmission, they indicate the PHY version identifier of the oldest PHY version implemented among the APs in the frame preamble (e.g., in the U-SIG field of the frame preamble). For example, if an EHT AP implementing an IEEE 802.11be wireless networking standard and a UHR AP implementing a beyond IEEE 802.11be wireless networking standard jointly operate a virtual BSS, the APs may indicate the PHY version identifier for the IEEE 802.11be wireless networking standard in the frame preambles.

By matching the parameters that are used by different APs participating in a multi-AP joint transmission (matching the scrambling seeds, BSS colors, and/or PHY version identifiers), embodiments ensure that the waveforms transmitted by different APs for the signal part and data part of the frames are identical (except for the beamforming matrices) and that the frames indicate the same (virtual) BSS color and PHY version identifier, thereby enabling the joint transmission to be successful.

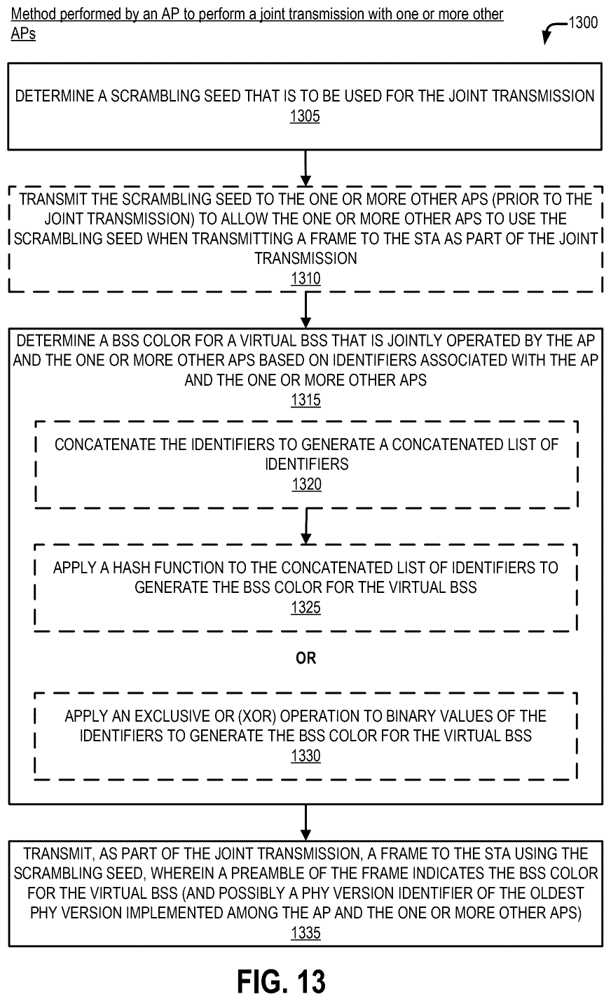

Turning now to FIG. 13, a method 1300 will be described for participating in a multi-AP joint transmission, in accordance with an example embodiment. The method 1300 may be performed by an AP that is to participate in a joint transmission with one or more other APs. The AP may be implemented by a wireless device (e.g., wireless device 104).

Additionally, although shown in a particular order, in some embodiments the operations of the method 1300 may be performed in a different order. For example, although the operations of the method 1300 are shown in a sequential order, some of the operations may be performed in partially or entirely overlapping time periods.

At operation 1305, the AP determines a scrambling seed that is to be used for the joint transmission (the scrambling seed that is to be used by the AP and the other APs when transmitting frames as part of the joint transmission).

In an embodiment, at operation 1310, the AP transmits the scrambling seed to the one or more other APs (prior to the joint transmission) to allow the one or more other APs to use the scrambling seed when transmitting a frame to the STA as part of the joint transmission. In an embodiment, the scrambling seed is transmitted in a sounding trigger frame. In an embodiment, the AP receives the scrambling seed from one of the one or more other APs. In an embodiment, the scrambling seed is received in a sounding trigger frame. In an embodiment, the scrambling seed is predefined or independently generated by the AP and the one or more other APs based on applying (the same) predefined rules.

At operation 1315, the AP determines a BSS color for a virtual BSS that is jointly operated by the AP and the one or more other APs based on identifiers associated with the AP and the one or more other APs. In an embodiment, the identifiers are any one of: AP addresses, BSS identifiers, and BSS colors. In an embodiment, operation 1315 involves operations 1320 and 1325. At operation 1320, the AP concatenates the identifiers to generate a concatenated list of identifiers. In an embodiment, the identifiers are concatenated in order of a participation order of the AP and the one or more other APs in a multi-AP coordination process. In an embodiment, the identifiers are concatenated in ascending or descending order of binary values of the identifiers. At operation 1325, the AP applies a hash function to the concatenated list of identifiers to generate the BSS color for the virtual BSS. In an alternative embodiment, operation 1315 involves operation 1330. At operation 1330, the AP applies a XOR operation to binary values of the identifiers to generate the BSS color for the virtual BSS.

At operation 1335, the AP transmits, as part of the joint transmission, a frame to the STA using the scrambling seed, wherein a preamble of the frame indicates the BSS color for the virtual BSS. In an embodiment, the AP determines an oldest PHY version implemented among the AP and the one or more other APs, wherein the preamble of the frame indicates a PHY version identifier of the oldest PHY version.

In an embodiment, the frame is a NDP announcement frame transmitted during a channel sounding process or a data frame that is transmitted following a channel sounding process. It should be appreciated, however, that the frame can be any type of frame that can benefit from a multi-AP joint transmission.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non- transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by an access point (AP) for participating in a joint transmission to a station (STA) with one or more other APs, the method comprising:
determining a scrambling seed that is to be used for the joint transmission;
determining a basic service set (BSS) color for a virtual BSS that is jointly operated by the AP and the one or more other APs based on identifiers associated with the AP and the one or more other APs; and
transmitting, as part of the joint transmission, a frame to the STA using the scrambling seed, wherein a preamble of the frame indicates the BSS color for the virtual BSS.

2. The method of claim 1, further comprising:
transmitting the scrambling seed to the one or more other APs prior to the joint transmission to allow the one or more other APs to use the scrambling seed when transmitting a frame to the STA as part of the joint transmission.

3. The method of claim 1, wherein the scrambling seed is predefined or independently generated by the AP and the one or more other APs based on applying predefined rules.

4. The method of claim 1, wherein the identifiers are any one of: AP addresses, BSS identifiers, and BSS colors.

5. The method of claim 1, wherein the determining the BSS color for the virtual BSS comprises:
concatenating the identifiers to generate a concatenated list of identifiers; and
applying a hash function to the concatenated list of identifiers to generate the BSS color for the virtual BSS.

6. The method of claim 5, wherein the identifiers are concatenated in order of a participation order of the AP and the one or more other APs in a multi-AP coordination process.

7. The method of claim 5, wherein the identifiers are concatenated in ascending or descending order of binary values of the identifiers.

8. The method of claim 1, wherein the determining the BSS color for the virtual BSS comprises:
applying an exclusive OR (XOR) operation to binary values of the identifiers to generate the BSS color for the virtual BSS.

9. The method of claim 1, further comprising:
determining an oldest physical layer (PHY) version implemented among the AP and the one or more other APs, wherein the preamble of the frame indicates a PHY version identifier of the oldest PHY version.

10. The method of claim 1, wherein the frame is a null data packet (NDP) announcement frame transmitted during a channel sounding process or a data frame that is transmitted following a channel sounding process.

11. A wireless device to implement an access point (AP), the wireless device comprising:
a radio frequency transceiver;
a memory device storing a set of instructions; and
a processor coupled to the memory device, wherein the set of instructions, when executed by the processor, causes the AP to:
determine a scrambling seed that is to be used for a joint transmission, wherein the AP and one or more other APs are to participate in the joint transmission to a station (STA);
determine a basic service set (BSS) color for a virtual BSS that is jointly operated by the AP and the one or more other APs based on identifiers associated with the AP and the one or more other APs; and
transmit, as part of the joint transmission, a frame to the STA using the scrambling seed, wherein a preamble of the frame indicates the BSS color for the virtual BSS.

12. The wireless device of claim 11, wherein the set of instructions, when executed the processor, further causes the AP to:
transmit the scrambling seed to the one or more other APs prior to the joint transmission to allow the one or more other APs to use the scrambling seed when transmitting a frame to the STA as part of the joint transmission.

13. The wireless device of claim 11, wherein the scrambling seed is predefined or independently generated by the AP and the one or more other APs based on applying predefined rules.

14. The wireless device of claim 11, wherein the identifiers are any one of: AP addresses, BSS identifiers, and BSS colors.

15. The wireless device of claim 11, wherein the determining the BSS color for the virtual BSS comprises:
concatenating the identifiers to generate a concatenated list of identifiers; and
applying a hash function to the concatenated list of identifiers to generate the BSS color for the virtual BSS.

16. A non-transitory machine-readable storage medium storing a set of computer instructions therein, which when executed by a processor of a wireless device implementing an access point (AP), causes the AP to perform operations for participating in a joint transmission to a station (STA) with one or more other APs, the operation comprising:
determining a scrambling seed that is to be used for a joint transmission;
determining a basic service set (BSS) color for a virtual BSS that is jointly operated by the AP and the one or more other APs based on identifiers associated with the AP and the one or more other APs; and
transmitting, as part of the joint transmission, a frame to the STA using the scrambling seed, wherein a preamble of the frame indicates the BSS color for the virtual BSS.

17. The non-transitory machine-readable storage medium of claim 16, wherein the operations further comprise:
transmitting the scrambling seed to the one or more other APs prior to the joint transmission to allow the one or more other APs to use the scrambling seed when transmitting a frame to the STA as part of the joint transmission.

18. The non-transitory machine-readable storage medium of claim 16, wherein the scrambling seed is predefined or independently generated by the AP and the one or more other APs based on applying predefined rules.

19. The non-transitory machine-readable storage medium of claim 16, wherein the identifiers are any one of: AP addresses, BSS identifiers, and BSS colors.

20. The non-transitory machine-readable storage medium of claim 16, wherein the determining the BSS color for the virtual BSS comprises:
concatenating the identifiers to generate a concatenated list of identifiers; and
applying a hash function to the concatenated list of identifiers to generate the BSS color for the virtual BSS.
